(19) United States
(12) Patent Application Publication
(10) Pub. No.: US 2024/0146691 A1
(43) Pub. Date: May 2, 2024

(54) DATA PROCESSING METHOD, LIVESTREAMING METHOD, AUTHENTICATION SERVER, AND LIVE DATA SERVER

(71) Applicant: SHANGHAI BILIBILI TECHNOLOGY CO., LTD., Shanghai (CN)

(72) Inventor: Yuanyuan SUN, Shanghai (CN)

(21) Appl. No.: 18/281,950

(22) PCT Filed: Jan. 20, 2022
(86) PCT No.: PCT/CN2022/073021

§ 371 Date: Sep. 13, 2023

(30) Foreign Application Priority Data
Mar. 15, 2021 (CN) 202110276712.6

(51) Int. Cl. H04L 9/40

(52) U.S. Cl. CPC H04L 63/0236; H04L 63/0263; H04L 63/1425

(57) ABSTRACT

This application provides techniques of processing data and livestreaming. The techniques comprise obtaining pulling information reported by the live data server, where the pulling information carries a request address and data traffic generated through pulling within a reporting period; computing total data traffic of a target request address within a statistical period; and determining, based on the total data traffic, whether the target request address is a blacklist address, where the target request address is any request address carried in the pulling information.

This application claims priority to Chinese Patent Application No. 202110276712.6, filed on Mar. 15, 2021, and entitled “DATA PROCESSING METHOD, LIVESTREAMING METHOD, AUTHENTICATION SERVER, AND LIVE DATA SERVER”, which is incorporated herein by reference in its entirety.

### TECHNICAL FIELD

This application relates to the field of network livestreaming technologies, and in particular, to a data processing method. In addition, this application relates to a livestreaming method, an authentication server, a live data server, a livestreaming system, a computing device, and a computer-readable storage medium.

### BACKGROUND

With improvement of a network communication technology and acceleration of a broadband network, livestreaming is more developed and applied. In an existing livestreaming system, popularity is an important indicator for ranking rooms of a livestreaming platform. Usually, higher popularity indicates a higher ranking and a higher possibility that an online streamer is watched by a user. A real-time quantity of viewers in a live room is a key part in popularity calculation. Consequently, to improve popularity, some online streamers use illegal means to simulate watching of live rooms, and forge quantities of online viewers in the live rooms, that is, improve popularity rankings through click-farming. However, a click-farming behavior wastes a bandwidth, and further causes an excessively large pressure on a server. Consequently, the server is prone to paralyzing. Therefore, a method for detecting and restraining a click-farming behavior in a live room needs to be provided urgently.

### SUMMARY

In view of this, embodiments of this application provide a data processing method. In addition, this application relates to a livestreaming method, an authentication server, a live data server, a livestreaming system, a computing device, and a computer-readable storage medium, to resolve problems, such as bandwidth waste and a large pressure on a server, caused by a click-farming behavior in the conventional technology.

According to a first aspect of the embodiments of this application, a data processing method is provided. The method is applied to an authentication server, and includes:
obtaining pulling information reported by a live data server, where the pulling information carries a request address and data traffic generated through pulling within a reporting period;
collecting statistics about total data traffic of a target request address within a statistical period; and
determining, based on the total data traffic, whether the target request address is a blacklist address, where the target request address is a request address carried in any of the pulling information.

According to a second aspect of the embodiments of this application, a livestreaming method is provided. The method is applied to a live data server, and includes:
determining, when a connection establishment request is received, a request address corresponding to the connection establishment request;
determining whether the request address is an address in a preset blacklist, establishing a connection to a requester when the request address is not an address in the preset blacklist, and returning a live video stream to the requester; and
collecting, at an interval of a reporting period, statistics about data traffic generated through pulling by using the request address within the reporting period, and reporting pulling information including the request address and the data traffic to an authentication server.

According to a third aspect of the embodiments of this application, an authentication server is provided. The server includes:
an obtaining module, configured to obtain pulling information reported by a live data server, where the pulling information carries a request address and data traffic generated through pulling within a reporting period;
a statistics collection module, configured to collect statistics about total data traffic of a target request address within a statistical period; and
a first determining module, configured to determine, based on the total data traffic, whether the target request address is a blacklist address, where the target request address is a request address carried in any of the pulling information.

According to a fourth aspect of the embodiments of this application, a live data server is provided. The server includes:
a second determining module, configured to determine, when a connection establishment request is received, a request address corresponding to the connection establishment request;
a third determining module, configured to determine whether the request address is an address in a preset blacklist, establish a connection to a requester when the request address is not an address in the preset blacklist, and return a live video stream to the requester; and
a reporting module, configured to collect, at an interval of a reporting period, statistics about data traffic generated through pulling by using the request address within the reporting period, and report pulling information including the request address and the data traffic to an authentication server.

According to a fifth aspect of the embodiments of this application, a livestreaming system is provided. The system includes a live data server and an authentication server.

The live data server is configured to: determine, when a connection establishment request is received, a request address corresponding to the connection establishment request; determine whether the request address is an address in a preset blacklist, establish a connection to a requester when the request address is not an address in the preset blacklist, and return a live video stream to the requester; collect, at an interval of a reporting period, statistics about data traffic generated through pulling by using the request address within the reporting period, and report pulling information including the request address and the data traffic to the authentication server; and send an obtaining request to the authentication server at an interval of an update period.

The authentication server is configured to: obtain the pulling information reported by the live data server, where the pulling information carries the request address and the data traffic generated through pulling within the reporting period; collect statistics about total data traffic of a target request address within a statistical period, and determine, based on the total data traffic, whether the target request address is a blacklist address, where the target request address is a request address carried in any of the pulling information; generate a blacklist based on a determined blacklist address; and return the blacklist to the live data server when the obtaining request sent by the live data server is received.

The live data server is further configured to receive the blacklist returned by the authentication server, and update the preset blacklist based on the blacklist returned by the authentication server.

According to a sixth aspect of the embodiments of this application, a computing device is provided, including:
a memory and a processor, where
the memory is configured to store computer-executable instructions, and the processor is configured to execute the computer-executable instructions to implement the following method:
obtaining pulling information reported by a live data server, where the pulling information carries a request address and data traffic generated through pulling within a reporting period;
collecting statistics about total data traffic of a target request address within a statistical period; and
determining, based on the total data traffic, whether the target request address is a blacklist address, where the target request address is a request address carried in any of the pulling information; or
determining, when a connection establishment request is received, a request address corresponding to the connection establishment request;
determining whether the request address is an address in a preset blacklist, establishing a connection to a requester when the request address is not an address in the preset blacklist, and returning a live video stream to the requester; and
collecting, at an interval of a reporting period, statistics about data traffic generated through pulling by using the request address within the reporting period, and reporting pulling information including the request address and the data traffic to an authentication server.

According to a seventh aspect of the embodiments of this application, a computer-readable storage medium is provided. The computer-readable storage medium stores computer-executable instructions, and when the computer-executable instructions are executed by a processor, the operation steps of any data processing method or livestreaming method are implemented.

In the data processing method provided in this application, the authentication server can obtain the pulling information reported by the live data server, where the pulling information carries the request address and the data traffic generated through pulling within the reporting period; the authentication server collects statistics about the total data traffic of the target request address within the statistical period; and the authentication server determines, based on the total data traffic, whether the target request address is a blacklist address, where the target request address is a request address carried in any of the pulling information. In this case, after establishing a connection to a livestreaming platform, the live data server can periodically report the pulling information of the livestreaming platform to the authentication server. The authentication server can collect statistics about the total data traffic of the target request address within the statistical period, to determine whether the target request address is a blacklist address for click-farming, thereby avoiding erroneous determining and improving accuracy of determining a click-farming address.

In the livestreaming method provided in this application, when receiving the connection establishment request, the live data server determines the request address corresponding to the connection establishment request; the live data server determines whether the request address is an address in the preset blacklist, establishes a connection to the requester when the request address is not an address in the preset blacklist, and returns the live video stream to the requester; and the live data server collects, at an interval of the reporting period, statistics about the data traffic generated through pulling by using the request address within the reporting period, and reports the pulling information including the request address and the data traffic to the authentication server. In this case, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of the livestreaming platform and the live data server. In addition, the live data server can collect, at an interval of the reporting period, statistics about the data traffic generated through pulling by using the request address within the reporting period, and report the data traffic to the authentication server, so that the authentication server analyzes the request address, and confirms whether the request address is a blacklist address for click-farming.

### BRIEF DESCRIPTION OF DRAWINGS

FIG. 1 is a flowchart of a data processing method according to an embodiment of this application;

FIG. 2 is a schematic flowchart of determining a blacklist address by an authentication server according to an embodiment of this application;

FIG. 3 is a flowchart of a livestreaming method according to an embodiment of this application;

FIG. 4 is a schematic flowchart of performing verification by a live data server according to an embodiment of this application;

FIG. 5 is a flowchart of a livestreaming method according to an embodiment of this application;

FIG. 6 is a schematic diagram of a live access procedure according to an embodiment of this application;

FIG. 7 is a schematic diagram of a structure of an authentication server according to an embodiment of this application;

FIG. 8 is a schematic diagram of a structure of a live data server according to an embodiment of this application;

FIG. 9 is a schematic diagram of a structure of a livestreaming system according to an embodiment of this application; and

FIG. 10 is a block diagram of a structure of a computing device according to an embodiment of this application.

### DESCRIPTION OF EMBODIMENTS

Many specific details are described in the following descriptions to facilitate full understanding of this application. However, this application can be implemented in many different manners from those described herein. A person skilled in the art may make similar promotion without departing from the connotation of this application. Therefore, this application is not limited to the specific implementations disclosed below.

Terms used in one or more embodiments of this application are merely used to describe specific embodiments, but are not intended to limit the one or more embodiments of this application. The terms “a” and “the” of singular forms used in one or more embodiments and the appended claims of this application are also intended to include plural forms, unless otherwise specified in the context clearly. It should be further understood that the term “and/or” used in one or more embodiments of this application indicates and includes any or all possible combinations of one or more associated listed items.

It should be understood that although terms such as “first” and “second” may be used in one or more embodiments of this application to describe various types of information, the information is not limited to these terms. These terms are merely used to differentiate between information of a same type. For example, without departing from the scope of one or more embodiments of this application, “first” may also be referred to as “second”, and similarly, “second” may also be referred to as “first”. Depending on the context, for example, the word “if” used herein may be explained as “while”, “when”, or “in response to determining”.

Noun terms related to one or more embodiments of this application are first explained.

Live stream: A live stream refers to transmission of live audio/video data, which can be transmitted as a stable and continuous stream to an audience via a network for watching.

Pushing: An online streamer obtains a streaming address from a livestreaming platform by using a service server (namely, an online streamer client), and pushes collected streaming media to a receive end of the livestreaming platform by using the streaming address in real time.

Pulling: Pulling refers to a process in which a user pulls a live stream from a specified origin server by using a livestreaming platform.

Live popularity: Live popularity refers to a value calculated based on a specific ratio by integrating a quantity of viewers, a quantity of bullet-screen connections, a quantity of gifts, and the like. The live popularity is used for ranking based on popularity at a livestreaming platform.

Quantity of live viewers: A quantity of live viewers is a real quantity of people watching a live room in real time.

Click-farming: Click-farming refers to a case in which a large amount of false watching is generated by simulating normal user access, that is, simulating watching of a live room by using an illegal means.

Click-farming prevention: Click-farming prevention refers to identifying an illegal access request by using a technical means, that is, identifying an access request of a blacklist address for click-farming, and refusing the illegal request.

Content delivery network (CDN): A content delivery network is constructed on a network. A basic principle of the CDN is as follows: Various cache servers are widely used, and these cache servers are delivered to an area or network with concentrated user access. When a user accesses a website, a global load technology is used to point user access to a nearest cache server that normally operates, and the cache server directly responds to a request of the user, thereby improving a response speed and a hit rate of user access. Key technologies of the CDN mainly include a content storage technology, a content delivery technology, and a load balancing technology.

Bandwidth: A bandwidth refers to a frequency bandwidth occupied by a signal. When the bandwidth is used to describe a channel, the bandwidth is a maximum frequency bandwidth of a signal that can effectively pass through the channel. A bandwidth in a unit of bit/second may also be referred to as a consumed bandwidth, and corresponds to implemented throughput, namely, an average rate of data successfully transmitted through a communication path. Within a studied time interval, a bandwidth of a bit stream is proportional to an averagely consumed signal bandwidth (representing an average spectrum bandwidth of an analog signal of a bit stream) in a unit of hertz.

Bit rate: A bit rate is a quantity of data bits transmitted per unit time during data transmission. The bit rate indicates a bit quantity required to indicate compressed and encoded audio/video data per second, namely, a data volume obtained after an image displayed per second is compressed, and a used unit is usually Kbps, namely, kilobits per second. A common understanding for the bit rate is a sampling rate. A larger sampling rate per unit time indicates higher precision, and a processed file is more similar to an original file, that is, a picture is more detailed.

In this application, a data processing method is provided. In addition, this application relates to a livestreaming method, an authentication server, a live data server, a livestreaming system, a computing device, and a computer-readable storage medium, which are described in detail one by one in the following embodiments.

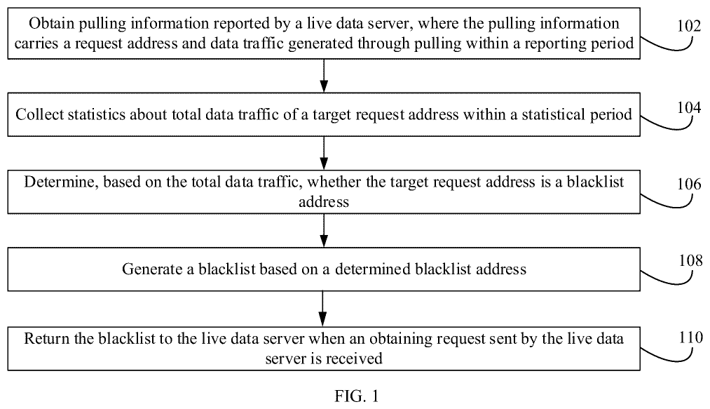

FIG. 1 is a flowchart of a data processing method according to an embodiment of this application. The method is applied to an authentication server, and specifically includes the following steps.

Step 102: Obtain pulling information reported by a live data server, where the pulling information carries a request address and data traffic generated through pulling within a reporting period.

It should be noted that an online streamer can perform pushing by using a livestreaming platform to push collected streaming media to a receive end of the livestreaming platform by using a streaming address in real time; and a user can perform pulling by using the livestreaming platform, that is, pull a live stream from a specified origin server by using the livestreaming platform for watching. A real-time quantity of viewers in a specific live room is used to determine popularity of the live room. In addition, one of manners for calculating a data source of a quantity of live viewers in the live room is to calculate a quantity of viewers of a CDN, that is, the CDN calculates a quantity of pulling connections of a live stream as the source of the quantity of live viewers. Therefore, to simulate watching of a live room by normal users, actual pulling may be performed by using a tool to forge a quantity of viewers in the live room. However, a bandwidth is generated through continuous pulling. Consequently, a large quantity of simulated connections cause fake live popularity, generate a large quantity of bandwidths, and cause a loss to the livestreaming platform. It is of great significance for maintaining ecology of the livestreaming platform by precisely determining whether click-farming exists in a live room, and taking a specific punishment measure for the click-farming room.

In an actual application, when click-farming prevention is performed during livestreaming, an access frequency of a specific request address within a short time is usually determined. If the access frequency of the request address within the short time is excessively high, it indicates that the request address may be a click-farming address. For example, a specific request address is used for access tens of thousands of times within one minute. This frequency exceeds an access frequency of a normal access behavior. Therefore, the request address may be a click-farming address.

However, when whether the request address is a click-farming address is determined based on the access frequency, a frequency threshold is preset. If a click-farming frequency is reduced so that an access frequency of a specific request address is less than the frequency threshold, and a click-farming time is prolonged, a click-farming effect can also be achieved. In this case, whether the request address is a click-farming address cannot be identified based on the frequency. Consequently, a click-farming address may be erroneously identified as a normal address. This causes poor accuracy of determining a click-farming address. For example, a maximum access frequency of one request address within one minute is preset to 100. When click-farming is performed, an access frequency of a specific request address within the minute may be 90. In this case, a quantity that is of live viewers and that is obtained after click-farming is 90. An access frequency within a next minute is also 90, and a quantity of live viewers within the next minute is 180. By analogy, the click-farming effect can be achieved, and the request address is identified as a normal access address by using the click-farming frequency. However, the request address is actually a click-farming address.

Therefore, to improve accuracy of determining a click-farming address, this application provides a data processing method. An authentication server may obtain pulling information reported by a live data server, where the pulling information carries a request address and data traffic generated through pulling within a reporting period; the authentication server collects statistics about total data traffic of a target request address within a statistical period; and the authentication server determines, based on the total data traffic, whether the target request address is a blacklist address, where the target request address is a request address carried in any of the pulling information. In this case, after establishing a connection to a livestreaming platform, the live data server can periodically report the pulling information of the livestreaming platform to the authentication server. The authentication server can collect statistics about the total data traffic of the target request address within the statistical period, to determine whether the target request address is a blacklist address for click-farming, thereby avoiding erroneous determining.

Specifically, the live data server is a server that provides live data for the livestreaming platform, that is, the live data server may return a video stream that a user requests to watch to the livestreaming platform, so that the user can watch wanted livestreaming by using the livestreaming platform. In this application, that the live data server is a content delivery network (CDN) is used as an example for description. The authentication server is a server that receives the pulling information reported by the live data server and analyzes and collects statistics about the received pulling information to determine a blacklist address, namely, a data analysis and calculation server.

In addition, the pulling information is a request address and corresponding pulling data that are reported by the live data server to the authentication server after the live data server establishes a connection to the livestreaming platform. In this way, the authentication server can collect statistics about and analyze each piece of obtained pulling data, to determine whether the data traffic generated through pulling by using the request address is normal, thereby determining whether the request address is a blacklist address for click-farming.

In addition, the reporting period is a preset time period, and the reporting period is a time interval at which the live data server reports the pulling information. For example, the reporting period may be 5 minutes, 20 minutes, or 30 minutes. After a user enters the livestreaming platform by using a specific request address, and normally establishes a connection to the live data server, a process in which the user watches livestreaming is actually a process of continuously performing pulling from the live data server. The authentication server can receive the request address and data traffic generated through pulling within the time period that are periodically reported by the live data server. The request address may be an Internet Protocol address (IP address) used by the user to request to watch livestreaming.

For example, the user enters the livestreaming platform by using a request address A, and normally establishes a connection to the live data server. The user watches corresponding livestreaming by using the request address A. It is assumed that the reporting period is 30 minutes. In this case, after the connection is successfully established (that is, when pulling starts), the live data server may report data traffic generated through pulling by using the request address within 30 minutes to the authentication server at an interval of 30 minutes. To be specific, pulling information obtained by the authentication server at the 30^{th} minute may be the request address A and data traffic X1 generated through pulling within 30 minutes; pulling information obtained by the authentication server at the 60^{th} minute may be the request address A and data traffic X2 generated through pulling within 30 minutes; and pulling information obtained by the authentication server at the 90^{th} minute may be the request address A and data traffic X3 generated through pulling within 30 minutes.

It should be noted that click-farming is performed to forge a quantity of viewers in a live room. Regardless of whether to reduce an access frequency, a specific quantity of viewers need to be finally reached, to be specific, continuous watching of livestreaming is required. Continuous watching of livestreaming requires continuous pulling, and corresponding data traffic is generated through pulling. Therefore, the request address can be identified based on the data traffic generated through pulling. The authentication server can obtain the pulling information periodically reported by the live data server, and can collect statistics about and analyze the pulling information subsequently, to determine whether the request address is a blacklist address for click-farming.

Step 104: Collect statistics about total data traffic of a target request address within a statistical period.

Specifically, on the basis of obtaining the pulling information reported by the live data server, statistics about the total data traffic of the target request address within the statistical period are further collected. The target request address is a request address carried in any of the pulling information.

It should be noted that the authentication server obtains a plurality of pieces of pulling information within a time period, each piece of pulling information carries a request address and data traffic generated through pulling within the reporting period, and different request addresses are sequentially used as the target request address to determine whether the request address is a blacklist address for click-farming. In addition, the target request address may be any IP address carried in the pulling information. Statistics are also collected based on a same IP address for a case in which a same IP address has different ports.

In an optional implementation of this embodiment, the pulling information further carries a reporting time; and a specific implementation process of collecting statistics about the total data traffic of the target request address within the statistical period may be as follows:
determining a reporting time carried in pulling information corresponding to the target request address; and
collecting statistics about data traffic carried in corresponding pulling information whose reporting time is within the statistical period, to obtain the total data traffic of the target request address within the statistical period.

Specifically, the reporting time is a reporting time at which the live data server reports the pulling information. The statistical period is a period in which the authentication server collects statistics about the total data traffic. For example, the statistical period may be 30 minutes, 5 hours, or 12 hours. In an actual implementation, when collecting statistics about the total data traffic of the target request address within the statistical period, the authentication server needs to first obtain the pulling information corresponding to the target request address by screening all the obtained pulling information, then obtains pulling information within the statistical period through screening based on the reporting time carried in the determined pulling information, and then accumulates the data traffic carried in the pulling information finally obtained through screening, to obtain the total data traffic of the target request address within the statistical period.

For example, the obtained pulling information is: pulling information 1: a request address A, data traffic X1 generated through pulling within 30 minutes, and a reporting time 00:30; pulling information 2: the request address A, data traffic X2 generated through pulling within 30 minutes, and a reporting time 01:00; pulling information 3: the request address A, data traffic X3 generated through pulling within 30 minutes, and a reporting time 01:30; pulling information 4: a request address B, data traffic Y1 generated through pulling within 60 minutes, and a reporting time 01:00; and pulling information 5: the request address B, data traffic Y2 generated through pulling within 60 minutes, and a reporting time 02:00.

It is assumed that the statistical period is 2 hours, and the request address A is the target request address. The pulling information 1, the pulling information 2, and the pulling information 3 corresponding to the request address A are first determined from the five pieces of pulling information. Then, pulling information that is within the 2 hours and that is separately obtained through screening based on the reporting times carried in the pulling information 1, the pulling information 2, and the pulling information 3 is the pulling information 1, the pulling information 2, and the pulling information 3. Statistics about the data traffic carried in the pulling information 1, the pulling information 2, and the pulling information 3 are collected, to obtain total data traffic X1+X2+X3 of the request address A within the 2 hours. Then, the request address B is used as the target request address, and the foregoing process is performed, to obtain total data traffic Y1+Y2 of the request address B within the 2 hours.

It should be noted that, after obtaining the pulling information periodically reported by the live data server, the authentication server can collect statistics about data traffic carried in pulling information corresponding to the target request address within a time period, to subsequently determine, based on the total data traffic within the time period, whether a pulling behavior of the target request address is abnormal, thereby determining whether the target request address is a blacklist address for click-farming.

Step 106: Determine, based on the total data traffic, whether the target request address is a blacklist address.

Specifically, on the basis of collecting statistics about the total data traffic of the target request address within the statistical period, whether the target request address is a blacklist address is further determined based on the total data traffic. The blacklist address is a forged click-farming address used to improve a quantity of live viewers.

In an optional implementation of this embodiment, a specific implementation process of determining, based on the total data traffic, whether the target request address is a blacklist address may be as follows:
determining whether the total data traffic is greater than an initial traffic threshold; and
if the total data traffic is greater than the initial traffic threshold, further determining, based on a geographical location of the target request address, whether the target request address is a blacklist address.

Specifically, the initial traffic threshold is a preset value, and is used to determine whether total data traffic generated through pulling by using a specific request address within a time period exceeds normal data traffic, to determine whether the request address is a blacklist address for click-farming. That is, the initial traffic threshold may be set based on data traffic generated through pulling when people normally watch livestreaming within the statistical period.

It should be noted that pulling is performed from the live data server when the user watches livestreaming, and corresponding data traffic is generated. Larger data traffic is generated within a longer watching time. For a specific request address, if data traffic generated within a time period exceeds data traffic (that is, the preset initial traffic threshold) that may be generated when people watch livestreaming, the request address may have a click-farming behavior. Therefore, after obtaining the pulling information periodically reported by the live data server, the authentication server can collect statistics about data traffic carried in pulling information corresponding to the target request address within a time period, to obtain total data traffic generated through pulling by using the target request address within the time period, and then compare the total data traffic with the preset initial traffic threshold. If the total data traffic is not greater than the initial traffic threshold, it indicates that the data traffic generated through pulling by using the request address within the time period is normal, and the request address is a request address for normal access. If the total data traffic is greater than the initial traffic threshold, it indicates that the data traffic generated through pulling by using the request address within the time period is excessively large, and click-farming may exist.

For example, it is assumed that a live room is continuously watched by using one request address for 12 hours, and a bit rate of the live room is 2 M. In this case, total data traffic that can be generated through pulling by using the request address within the 12 hours is 12*60*60 (seconds)*2 M=86400 M, and is converted to 86400/1024=84 G. In this case, the initial traffic threshold may be set to 84 G. If it is found through subsequent statistics collection that total data traffic generated when the live room is watched by using a specific request address exceeds 84 G, it indicates that more than one link may be established by using the request address to watch the live room, and many watching requests may be simultaneously simulated, that is, the request address may be a blacklist address for click-farming.

It should be noted that one or more export request addresses may be often used in schools and some densely populated areas, and there may be a large quantity of users corresponding to the request address. In other words, request address reuse values of some areas are high. Therefore, total data traffic generated through pulling by using a specific request address within a time period may exceed total data traffic generated when a single user performs normal watching. Further, to avoid erroneously determining a request address for normal access as a blacklist address for click-farming, in this application, when it is determined that the total data traffic of the target request address within the statistical period is greater than the initial traffic threshold, the target request address is not directly determined as a blacklist address for click-farming, but further determining is performed on the target request address based on the geographical location of the target request address.

In an optional implementation of this embodiment, a specific implementation process of determining, based on the geographical location of the target request address, whether the target request address is a blacklist address may be as follows:
determining a target area to which the geographical location of the target request address belongs;
determining a request address reuse value corresponding to the target area, and determining whether the request address reuse value of the target area is greater than a preset threshold;
if the request address reuse value of the target area is greater than the preset threshold, determining a corresponding updated traffic threshold based on the target area;
determining whether the total data traffic is greater than the updated traffic threshold; and
if the total data traffic is greater than the updated traffic threshold, determining, based on a quantity of live rooms accessed by the target request address within the statistical period, whether the target request address is a blacklist address.

Specifically, the target area is an area in which the geographical location of the target request address is located. The request address reuse value is a value used to indicate a request address reuse case in the target area. A larger value indicates a higher request address reuse rate. For example, for densely populated areas such as a neighborhood, a school, and a hospital, a high request address reuse value is set, which indicates a high request address reuse rate in the target area. In other words, a same request address may be used by many users. The preset threshold is a preset value, and is used to determine whether an area is an area with a large request address reuse value.

It should be noted that, if the request address reuse value of the target area is large, a plurality of users may watch livestreaming by using a same request address. However, the initial traffic threshold is usually set based on total data traffic generated when a single user performs normal watching. In this case, the data traffic generated through pulling by using the request address may be greater than the set initial traffic threshold. Therefore, if the request address reuse value of the target area is large, it indicates that the target request address is a request address in an area with a high request address reuse rate. In this case, the initial traffic threshold may be increased to obtain the updated traffic threshold, and then whether the total data traffic of the target request address within the statistical period is greater than the updated traffic threshold is determined, to further determine whether the request address is a blacklist address for click-farming. If the request address reuse value of the target area is small, it indicates that the target request address is not a request address in an area with a high request address reuse rate. In this case, it can be directly determined that the request address is a blacklist address for click-farming. In this way, a corresponding traffic threshold can be dynamically adjusted based on the geographical location of the target request address, so that accuracy of determining a blacklist address for click-farming is higher.

In a specific implementation, the geographical location of the request address may be accurately determined by using a global positioning system (GPS). If the geographical location is the target area (namely, an area with a high population density), the initial traffic threshold may be increased based on the target area to obtain the updated traffic threshold.

In an optional implementation of this embodiment, a specific implementation process of determining the request address reuse value corresponding to the target area may be as follows:
determining the request address reuse value corresponding to the target area based on area property of the target area;
determining the request address reuse value corresponding to the target area based on area property of the target area and a statistical time; or
determining the request address reuse value corresponding to the target area based on a population density of the target area.

Specifically, the area property is an attribute of the target area. For example, the area property may be a neighborhood, a school, a hospital, a unit, or the like. The corresponding request address reuse value may be determined based on the area property of the target area. For example, a small quantity of request addresses are predetermined and allocated for a specific unit. There are usually a large quantity of staffs in the unit, but there are only several fixed request addresses. Therefore, it may be determined that a request address reuse value of the target area with the “unit” area property is high.

In an actual implementation, a correspondence between area property and a request address reuse value may be prestored. After the target area to which the geographical location of the target request address belongs is determined, the area property of the target area may be further determined, and then the request address reuse value corresponding to the area property is determined based on the correspondence between area property and a request address reuse value.

For example, the correspondence between area property and a request address reuse value is shown in the following Table 1. It is assumed that the target area to which the geographical location of the target request address belongs is A, where A is a unit. It can be learned from the following Table 1 that the request address reuse value corresponding to the target area is X4.

TABLE 1
Correspondence between area property
and a request address reuse value

| Area | Request address |
|---|---|
| property | reuse value |
| School | X1 |
| Neighborhood | X2 |
| Hospital | X3 |
| Unit | X4 |

In addition, because populations in some areas may be different at different times, the request address reuse value is related to the statistical time. Therefore, in addition to the area property of the target area, the request address reuse value corresponding to the target area may be further determined based on the area property of the target area and the statistical time. For example, a request address reuse rate of a school significantly decreases during holidays; and a request address reuse rate of a unit also decreases after work.

In an actual implementation, a correspondence among area property, a statistical time, and a request address reuse value may be prestored. After the target area to which the geographical location of the target request address belongs is determined, the area property of the target area and the current statistical time may be further determined, and then the request address reuse value corresponding to the area property at the current statistical time is determined based on the correspondence among area property, a statistical time, and a request address reuse value.

For example, the correspondence among area property, a statistical time, and a request address reuse value is shown in the following Table 2. It is assumed that the target area to which the geographical location of the target request address belongs is A, where A is a unit; and it is assumed that the statistical time is 10 o'clock. It can be learned from the following Table 2 that the request address reuse value corresponding to the target area is Y3.

TABLE 2
Correspondence among area property, a statistical
time, and a request address reuse value

| Area | | Request address |
|---|---|---|
| property | Statistical time | reuse value |
| School | February to June, and September to | Y1 |
| | December | |
| | January, July, and August | Y2 |
| Unit | 8 o'clock to 18 o'clock | Y3 |
| | 18 o'clock to 8 o'clock the next day | Y4 |

In addition, because the request address reuse value is related to the population density, the corresponding request address reuse value may be further directly determined based on the population density of the target area. In a specific implementation, a correspondence between a density interval and a request address reuse value may be preset. After the target area to which the geographical location of the target request address belongs is determined, the population density of the target area may be further determined, and then the request address reuse value corresponding to the population density is determined based on the correspondence between a density interval and a request address reuse value.

For example, the correspondence between a density interval and a request address reuse value is shown in the following Table 3. It is assumed that the target area to which the geographical location of the target request address belongs is A, the population density of A is K, and K is greater than E3. It can be learned from the following Table 3 that the request address reuse value corresponding to the target area is Z4.

TABLE 3
Correspondence between a density interval
and a request address reuse value

| Density | Request address |
|---|---|
| interval | reuse value |
| <E1 | Z1 |
| E1 to E2 | Z2 |
| E2 to E3 | Z3 |
| >E3 | Z4 |

In an optional implementation of this embodiment, a specific implementation process of determining the corresponding updated traffic threshold based on the target area may be as follows:
determining the updated traffic threshold corresponding to area property of the target area based on a prestored correspondence between area property and a traffic threshold.

It should be noted that, for some areas with high request address reuse values, a traffic threshold corresponding to the area may be preset based on area property of the area, to generate a correspondence between area property and a traffic threshold. Subsequently, the traffic threshold corresponding to the area property of the target area may be directly obtained as the updated traffic threshold.

For example, the correspondence between area property and a traffic threshold is shown in the following Table 4. It is assumed that the area property of the target area to which the geographical location of the target request address belongs is a school. It can be learned from the following Table 4 that the traffic threshold corresponding to the school is M. In this case, it is determined that the updated traffic threshold is M, and whether the total data traffic of the target request address within the statistical period is greater than the updated traffic threshold M is redetermined.

TABLE 4
Correspondence between area property and a traffic threshold

| Area | Traffic |
|---|---|
| property | threshold |
| School | M |
| Neighborhood | N |
| Hospital | P |
| Other | Q |

It should be noted that most watched live rooms are usually different due to personal preferences when the population density is large. In other words, if a plurality of users use a same request address to watch livestreaming, accessed live rooms are usually scattered. Therefore, to avoid erroneously determining a request address for normal access as a blacklist address for click-farming, in this application, when it is determined that the total data traffic of the target request address within the statistical period is greater than the updated traffic threshold, the target request address is not directly determined as a blacklist address for click-farming, but further determining is performed on the target request address based on information about a live room accessed by the target request address.

In an optional implementation of this embodiment, the pulling information further carries a live room identifier; and a specific implementation process of determining, based on the quantity of live rooms accessed by the target request address within the statistical period, whether the target request address is a blacklist address may be as follows:
collecting, based on the live room identifier carried in the pulling information corresponding to the target request address, statistics about the quantity of live rooms accessed by the target request address within the statistical period;
determining whether the quantity of live rooms accessed by the target request address within the statistical period is less than a preset quantity threshold; and
if the quantity of live rooms accessed by the target request address within the statistical period is less than the preset quantity threshold, determining that the target request address is a blacklist address.

Specifically, the preset quantity threshold is a preset value, and is used to determine whether the live rooms accessed by the target request address are scattered. If the quantity of live rooms accessed by the target request address within the statistical period is not less than the preset quantity threshold, it indicates that the live rooms accessed by the target request address are scattered, and the target request address is a normal access address. If the quantity of live rooms accessed by the target request address within the statistical period is less than the preset quantity threshold, it indicates that the live rooms accessed by the target request address are concentrated, and the target request address may be a blacklist address for click-farming.

In this application, a click farmer needs to access only a fixed live room without accessing an irrelevant live room. However, a normal access user accesses different live rooms due to personal preferences. Therefore, if data traffic generated through pulling by using a specific request address is high, and a corresponding geographical location belongs to the target area (namely, an area with a high population density), but live rooms accessed by the request address are several fixed live rooms, the request address may be a blacklist address for click-farming. In this way, statistics about the total data traffic of the target request address within the statistical period can be collected, and a standard for determining a blacklist address for click-farming is dynamically adjusted based on the geographical location of the target request address and the quantity of accessed live rooms, thereby comprehensively determining whether the target request address is a blacklist address for click-farming, avoiding erroneous determining, and improving accuracy of determining a click-farming address.

Step 108: Generate a blacklist based on a determined blacklist address.

Specifically, on the basis of determining, based on the total data traffic, whether the target request address is a blacklist address, the blacklist is further generated based on the determined blacklist address.

In an optional implementation of this embodiment, a specific implementation process of generating the blacklist based on the determined blacklist address may be as follows:
determining whether a target blacklist address that does not exist within a previous statistical period exists within a current statistical period; and
if the target blacklist address that does not exist within the previous statistical period exists within the current statistical period, adding the target blacklist address to a blacklist generated within the previous statistical period, to generate a blacklist corresponding to the current statistical period.

It should be noted that a blacklist address within a time period is determined at an interval of the statistical period. Therefore, each time a new blacklist address is determined, the blacklist address needs to be added to a blacklist generated last time. Therefore, the blacklist can be updated once, provided that the statistical period is reached. In this way, the blacklist can be continuously updated based on a newly determined blacklist address, thereby ensuring real-time performance of the generated blacklist.

Step 110: Return the blacklist to the live data server when an obtaining request sent by the live data server is received.

Specifically, on the basis of generating the blacklist based on the determined blacklist address, the blacklist is further returned to the live data server when the obtaining request sent by the live data server is received.

In an optional implementation of this embodiment, a specific implementation process of returning the blacklist to the live data server when the obtaining request sent by the live data server is received may be as follows:
when the obtaining request sent by the live data server is received, obtaining a target blacklist corresponding to a current statistical period; and
returning the target blacklist to the live data server.

It should be noted that the live data server periodically reads the blacklist from the authentication server to verify a subsequent connection request. Therefore, when receiving the obtaining request, the authentication server can return the latest generated blacklist to the live data server, namely, a blacklist generated based on a connection parameter obtained within the current statistical period.

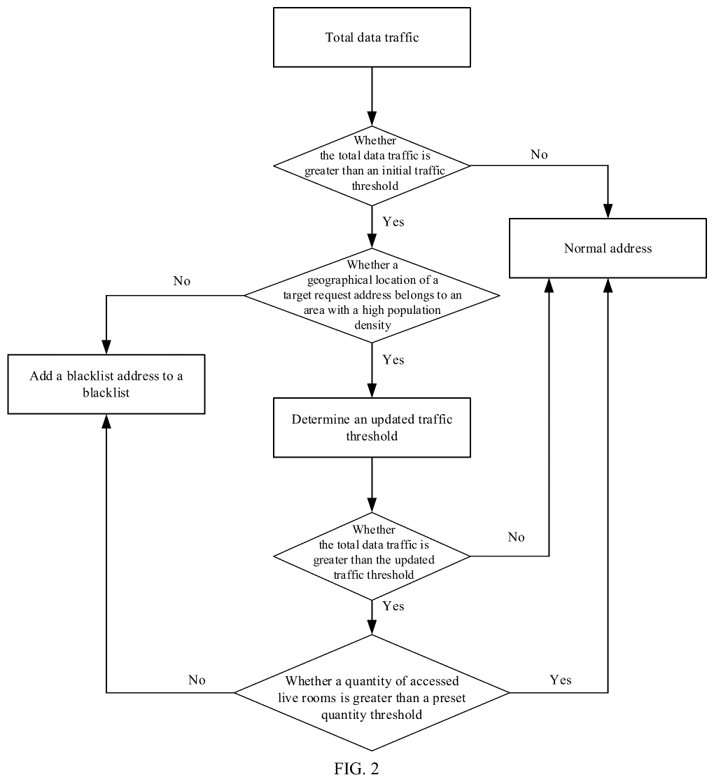

For example, FIG. 2 is a schematic flowchart of determining a blacklist address by an authentication server according to an embodiment of this application. As shown in FIG. 2, the authentication server collects statistics about the total data traffic generated through pulling by using the target request address within the statistical period, and determines whether the total data traffic is greater than the initial traffic threshold. If the total data traffic is not greater than the initial traffic threshold, the authentication server determines that the target request address is a normal address. If the total data traffic is greater than the initial traffic threshold, the authentication server further determines whether the geographical location of the target request address belongs to the area with a high population density. If the geographical location of the target request address does not belong to the area with a high population density, the authentication server determines that the target request address is a blacklist address, and adds the blacklist address to the blacklist. If the geographical location of the target request address belongs to the area with a high population density, the authentication server determines the updated traffic threshold, and determines whether the total data traffic is greater than the updated traffic threshold. If the total data traffic is not greater than the updated traffic threshold, the authentication server determines that the target request address is a normal address. If the total data traffic is greater than the updated traffic threshold, the authentication server further determines whether the quantity of live rooms accessed by the target request address is greater than the preset quantity threshold. If the quantity of live rooms accessed by the target request address is greater than the preset quantity threshold, the authentication server determines that the target request address is a normal address. If the quantity of live rooms accessed by the target request address is not greater than the preset quantity threshold, the authentication server determines that the target request address is a blacklist address, and adds the blacklist address to the blacklist.

In the data processing method provided in this application, the authentication server can obtain the pulling information reported by the live data server, where the pulling information carries the request address and the data traffic generated through pulling within the reporting period; the authentication server collects statistics about the total data traffic of the target request address within the statistical period, determines, when the total data traffic is greater than the initial traffic threshold, whether the geographical location of the target request address belongs to the target area, determines the corresponding updated traffic threshold when the geographical location of the target request address belongs to the target area, and further determines whether the total data traffic is greater than the updated traffic threshold; when the total data traffic is greater than the updated traffic threshold, the authentication server collects, based on the live room identifier carried in the pulling information corresponding to the target request address, statistics about the quantity of live rooms accessed by the target request address within the statistical period, and when the quantity of live rooms accessed by the target request address within the statistical period is greater than the preset quantity threshold, determines that the target request address is a blacklist address.

In this case, after establishing a connection to the livestreaming platform, the live data server can periodically report the pulling information of the livestreaming platform to the authentication server. The authentication server can collect statistics about the total data traffic of the target request address within the statistical period, and dynamically adjust, based on the geographical location of the target request address and the quantity of accessed live rooms, the standard for determining a blacklist address for click-farming, thereby comprehensively determining whether the target request address is a blacklist address for click-farming, avoiding erroneous determining, and improving accuracy of determining a click-farming address.

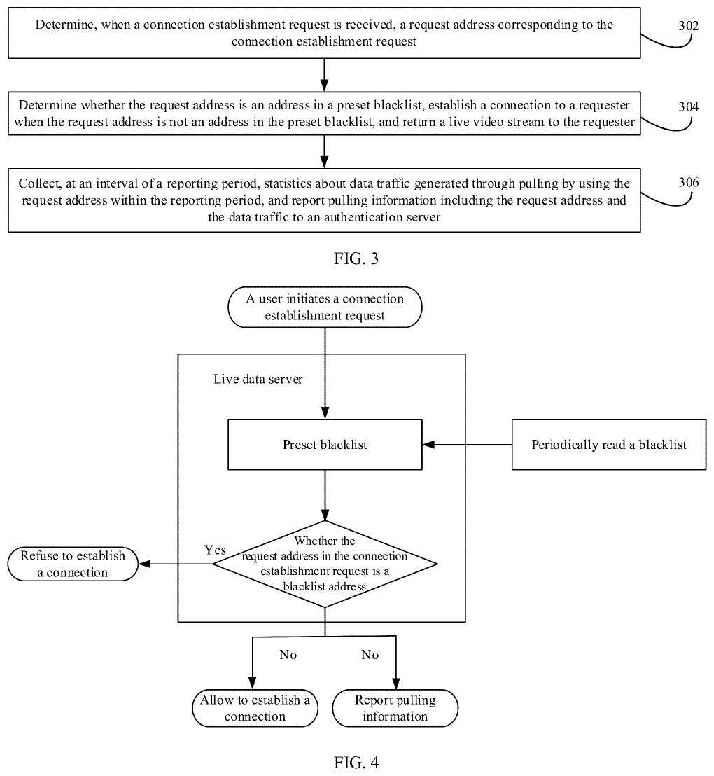

FIG. 3 is a flowchart of a livestreaming method according to an embodiment of this application. The method is applied to a live data server, and specifically includes the following steps.

Step 302: Determine, when a connection establishment request is received, a request address corresponding to the connection establishment request.

In an actual application, a click-farming prevention means is usually used the next day after click-farming occurs or when live popularity is subsequently calculated, to determine a corresponding click-farming quantity, and perform deduction. In this manner, timeliness is poor, only fairness of the live popularity can be ensured, and bandwidth waste caused by click-farming cannot be avoided.

Therefore, to save a bandwidth, this application provides a livestreaming method. When receiving the connection establishment request, the live data server determines the request address corresponding to the connection establishment request; the live data server determines whether the request address is an address in a preset blacklist, establishes a connection to a requester when the request address is not an address in the preset blacklist, and returns a live video stream to the requester; and the live data server collects, at an interval of a reporting period, statistics about data traffic generated through pulling by using the request address within the reporting period, and reports pulling information including the request address and the data traffic to an authentication server. In this case, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of a livestreaming platform and the live data server.

Specifically, the connection establishment request is a request initiated by the livestreaming platform based on an obtained playback address (that is, a sign field and a live stream identifier), and is used to request to establish a connection to the live data server, to obtain the live video stream. Therefore, the connection establishment request carries the corresponding request address, to subsequently report the pulling information to the authentication server.

In an optional implementation of this embodiment, the live data server may periodically read a blacklist from the authentication server, to perform authentication on the received connection establishment request. Therefore, before the determining, when a connection establishment request is received, a request address corresponding to the connection establishment request, the method further includes:
sending an obtaining request to the authentication server at an interval of an update period;
receiving a blacklist returned by the authentication server, where the blacklist is generated by the authentication server based on total data traffic of the request address within a statistical period; and
updating the preset blacklist based on the blacklist returned by the authentication server.

Specifically, the update period is a preset time period, and the update period is a time interval at which the live data server reads the blacklist from the authentication server. For example, the live data server reads the blacklist once every 5 hours, and the update period is 5 hours.

It should be noted that a blacklist may be preset on the live data server. The blacklist may be empty, or may include some public blacklist addresses. Subsequently, the preset blacklist is updated in real time based on the blacklist read from the authentication server, thereby ensuring timeliness of implementing click-farming prevention.

Step 304: Determine whether the request address is an address in a preset blacklist, establish a connection to a requester when the request address is not an address in the preset blacklist, and return a live video stream to the requester.

Specifically, the requester is a party that sends the connection establishment request, for example, the livestreaming platform. It should be noted that the live data server can verify the request address in the connection establishment request after receiving the connection establishment request, to determine whether the request address is a blacklist address in the blacklist. If the request address in the connection establishment request is not a blacklist address, it indicates that the current request address is an access address of a normal user, the live data server allows the user to establish a connection for watching livestreaming, and returns the live video stream to the requester.

In an optional implementation of this embodiment, after the determining whether the request address is an address in a preset blacklist, the method further includes:
refusing to establish a connection to the requester when the request address is an address in the preset blacklist.

In an actual application, when determining that the request address is an address in the preset blacklist, the live data server does not need to send the connection establishment request to the authentication server, because an objective of access prohibition is already achieved.

It should be noted that, if the request address in the connection establishment request is a blacklist address, it indicates that the current request address is an illegal access address (namely, an access address for click-farming), the live data server refuses to establish a connection to the requester, and prohibits access of the requester, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of the livestreaming platform and the live data server.

Step 306: Collect, at an interval of a reporting period, statistics about data traffic generated through pulling by using the request address within the reporting period, and report pulling information including the request address and the data traffic to the authentication server.

Specifically, on the basis of establishing a connection to the requester and returning the live video stream to the requester, statistics about the data traffic generated through pulling by using the request address within the reporting period are further collected at an interval of the reporting period, and the pulling information including the request address and the data traffic is reported to the authentication server.

It should be noted that, after a user enters the livestreaming platform by using a specific request address, and normally establishes a connection to the live data server, a process in which the user watches livestreaming is actually a process of continuously performing pulling from the live data server. The live data server can periodically collect statistics about data traffic generated through pulling by using the specific request address within the time period, and report the data traffic to the authentication server. The authentication server analyzes and collects statistics about the received pulling information to determine a blacklist address for click-farming.

In an optional implementation of this embodiment, after the collecting, at an interval of a reporting period, statistics about data traffic generated through pulling by using the request address within the reporting period, and reporting pulling information including the request address and the data traffic to the authentication server, the method further includes:
stopping reporting the pulling information when the requester stops obtaining the live video stream.

It should be noted that the requester needs to continuously perform pulling from the live data server in the process in which the user normally watches livestreaming, thereby continuously generating data traffic. Therefore, the live data server can periodically collect statistics about the data traffic generated through pulling within the time period, and report the request address and the data traffic generated through pulling to the authentication server. When the user ends watching, that is, stops watching livestreaming, the requester stops obtaining the live video stream and stops performing pulling from the live data server. Therefore, the reporting process may be stopped in this case.

For example, the user enters the livestreaming platform by using a request address A, and normally establishes a connection to the live data server. The user watches corresponding livestreaming by using the request address A. In this case, after the connection is successfully established (that is, when pulling starts), the live data server can report data traffic generated through pulling by using the request address within 30 minutes to the authentication server at an interval of 30 minutes. To be specific, the live data server may collect, at the 30^{th} minute, statistics about data traffic generated through pulling within 30 minutes, and reported pulling information may be the request address A and the data traffic X1 generated through pulling within the 30 minutes; the live data server may collect, at the 60^{th} minute, statistics about data traffic generated through pulling from the 30^{th} minute to the 60^{th} minute, and pulling information reported by the live data server may be the request address A and the data traffic X2 generated through pulling within the 30 minutes; and the live data server may collect, at the 90^{th} minute, statistics about data traffic generated through pulling from the 60^{th} minute to the 90^{th} minute, and pulling information reported by the live data server may be the request address A and the data traffic X3 generated through pulling within the 30 minutes. This time of reporting is stopped when the user stops watching livestreaming (that is, stops pulling).

In an optional implementation of this embodiment, the reporting pulling information including the request address and the data traffic to the authentication server includes:
determining a live room identifier corresponding to the connection establishment request; and
reporting the pulling information including the request address, the data traffic, and the live room identifier to the authentication server.

It should be noted that, to help the authentication server subsequently analyze a scattering case of live rooms accessed by the request address, when reporting the pulling information to the authentication server, the live data server may further add the live room identifier to the pulling information, that is, the pulling information includes the request address, the data traffic, and the live room identifier in this case.

For example, FIG. 4 is a schematic flowchart of performing verification by a live data server according to an embodiment of this application. As shown in FIG. 4, the live data server periodically reads the blacklist generated by the authentication server, to obtain an updated preset blacklist. When the user initiates the connection establishment request by using the livestreaming platform, the live data server determines whether the request address in the connection establishment request is a blacklist address. If the request address in the connection establishment request is a blacklist address, the live data server refuses to establish a connection to the requester (that is, refuses this time of pulling), and the user cannot watch livestreaming. If the request address in the connection establishment request is not a blacklist address, the live data server allows to establish a connection to the requester, the user normally watches livestreaming, and the live data server reports a connection parameter of the connection establishment request to the authentication server.

In the livestreaming method provided in this application, when receiving the connection establishment request, the live data server determines the request address corresponding to the connection establishment request; the live data server determines whether the request address is an address in the preset blacklist, establishes a connection to the requester when the request address is not an address in the preset blacklist, and returns the live video stream to the requester; and the live data server collects, at an interval of the reporting period, statistics about the data traffic generated through pulling by using the request address within the reporting period, and reports the pulling information including the request address and the data traffic to the authentication server. In this case, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of a livestreaming platform and the live data server. In addition, the live data server can collect, at an interval of the reporting period, statistics about the data traffic generated through pulling by using the request address within the reporting period, and report the data traffic to the authentication server, so that the authentication server analyzes the request address, and confirms whether the request address is a blacklist address for click-farming.

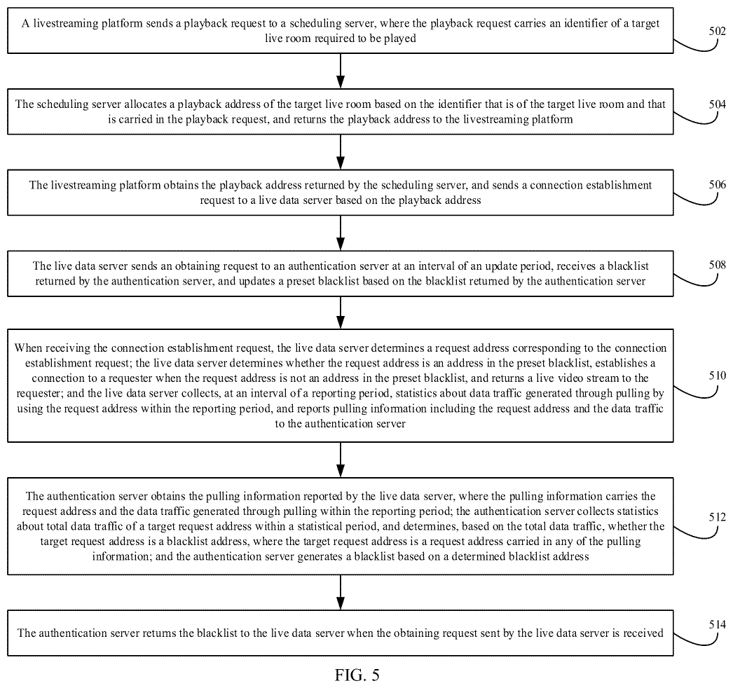

FIG. 5 is a flowchart of a livestreaming method according to an embodiment of this application. The method specifically includes the following steps:

Step 502: A livestreaming platform sends a playback request to a scheduling server, where the playback request carries an identifier of a target live room required to be played.

Step 504: The scheduling server allocates a playback address of the target live room based on the identifier that is of the target live room and that is carried in the playback request, and returns the playback address to the livestreaming platform.

Step 506: The livestreaming platform obtains the playback address returned by the scheduling server, and sends a connection establishment request to a live data server based on the playback address.

Step 508: The live data server sends an obtaining request to an authentication server at an interval of an update period, receives a blacklist returned by the authentication server, and updates a preset blacklist based on the blacklist returned by the authentication server.

Step 510: When receiving the connection establishment request, the live data server determines a request address corresponding to the connection establishment request; the live data server determines whether the request address is an address in the preset blacklist, establishes a connection to a requester when the request address is not an address in the preset blacklist, and returns a live video stream to the requester; and the live data server collects, at an interval of a reporting period, statistics about data traffic generated through pulling by using the request address within the reporting period, and reports pulling information including the request address and the data traffic to the authentication server.

Step 512: The authentication server obtains the pulling information reported by the live data server, where the pulling information carries the request address and the data traffic generated through pulling within the reporting period; the authentication server collects statistics about total data traffic of a target request address within a statistical period, and determines, based on the total data traffic, whether the target request address is a blacklist address, where the target request address is a request address carried in any of the pulling information; and the authentication server generates a blacklist based on a determined blacklist address.

Step 514: The authentication server returns the blacklist to the live data server when the obtaining request sent by the live data server is received.

It should be noted that the livestreaming platform automatically requests the playback address of the live room from the scheduling server when a user enters the live room, and a scheduling server may allocate, based on the identifier of the target live room in the playback request, the playback address corresponding to the live room. The playback address includes a sign field (sign field) and a live stream identifier field (stream name field). After the livestreaming platform obtains the playback address returned by the scheduling system, there are two operation manners. One operation manner is that a normal user directly normally performs playback and watching by using the livestreaming platform, that is, a player of the livestreaming platform automatically requests to establish a link to the live data server, and the user can perform watching after the live data server verifies that the playback request is valid. The other manner is that a viewer is illegally simulated, the playback address is copied, the playback address is requested in batches by using a tool, a connection to the live data server is requested to be established, and after the live data server verifies that the playback request is valid, livestreaming can be watched. Therefore, after receiving the connection establishment request, the live data server needs to determine whether the request is a normal access request or an illegal access request for click-farming, to determine whether to allow access.

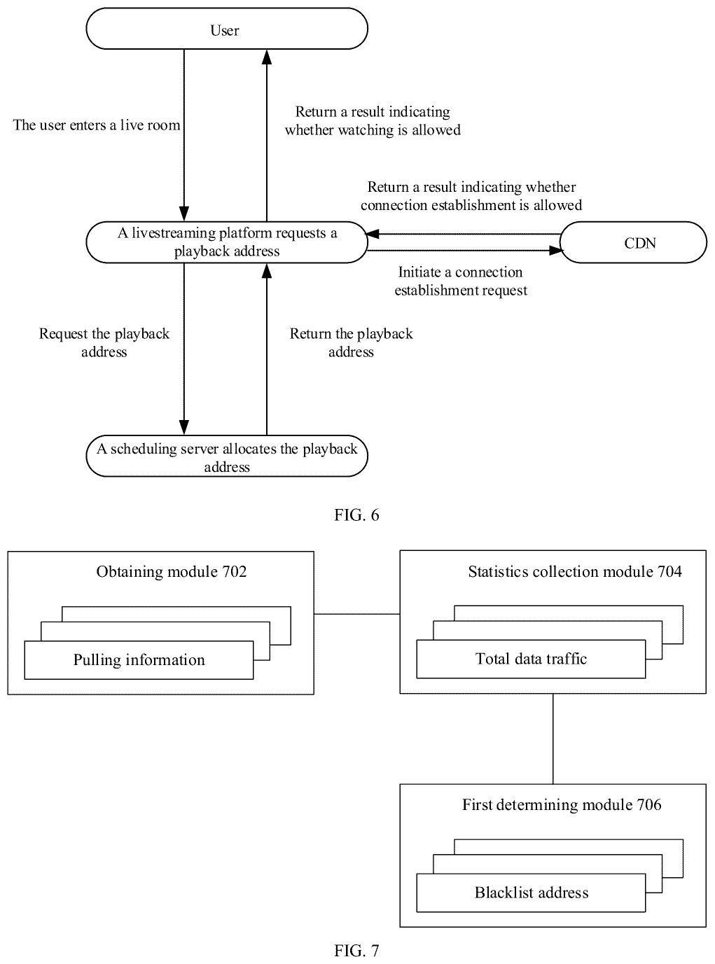

For example, FIG. 6 is a schematic diagram of a live access procedure according to an embodiment of this application. As shown in FIG. 6, a user enters a live room, a livestreaming platform requests a playback address from a scheduling server, and the scheduling server allocates and returns the playback address. After obtaining the playback address, the livestreaming platform sends a connection establishment request to a CDN. The CDN determines, based on a blacklist, whether connection establishment is allowed, and returns a response. The livestreaming platform receives the response that is returned by the CDN and that indicates whether connection establishment is allowed, and returns, to the user, a result indicating whether watching is allowed.

In the livestreaming method provided in this application, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of the livestreaming platform and the live data server. In addition, the live data server can collect, at an interval of the reporting period, statistics about the data traffic generated through pulling by using the request address within the reporting period, and report the data traffic to the authentication server. The authentication server can collect statistics about the total data traffic of the target request address within the statistical period, and dynamically adjust, based on a geographical location of the target request address and a quantity of accessed live rooms, a standard for determining a blacklist address for click-farming, to accurately determine whether the target request address is a blacklist address for click-farming, thereby further ensuring that the live data server can accurately limit illegal access for click-farming, and saving a bandwidth.

This application further provides an authentication server embodiment corresponding to the foregoing method embodiment. FIG. 7 is a schematic diagram of a structure of an authentication server according to an embodiment of this application. As shown in FIG. 7, the authentication server apparatus includes:
an obtaining module 702, configured to obtain pulling information reported by a live data server, where the pulling information carries a request address and data traffic generated through pulling within a reporting period;
a statistics collection module 704, configured to collect statistics about total data traffic of a target request address within a statistical period; and
a first determining module 706, configured to determine, based on the total data traffic, whether the target request address is a blacklist address, where the target request address is a request address carried in any of the pulling information.

Optionally, the first determining module 706 is further configured to:
determine whether the total data traffic is greater than an initial traffic threshold; and
if the total data traffic is greater than the initial traffic threshold, further determine, based on a geographical location of the target request address, whether the target request address is a blacklist address.

Optionally, the first determining module 706 is further configured to:
determine a target area to which the geographical location of the target request address belongs;
determine a request address reuse value corresponding to the target area, and determine whether the request address reuse value of the target area is greater than a preset threshold;
if the request address reuse value of the target area is greater than the preset threshold, determine a corresponding updated traffic threshold based on the target area;
determine whether the total data traffic is greater than the updated traffic threshold; and
if the total data traffic is greater than the updated traffic threshold, determine, based on a quantity of live rooms accessed by the target request address within the statistical period, whether the target request address is a blacklist address.

Optionally, the first determining module 706 is further configured to:
determine the request address reuse value corresponding to the target area based on area property of the target area;
determine the request address reuse value corresponding to the target area based on area property of the target area and a statistical time; or determine the request address reuse value corresponding to the target area based on a population density of the target area.

Optionally, the first determining module 706 is further configured to:
collect, based on the live room identifier carried in the pulling information corresponding to the target request address, statistics about the quantity of live rooms accessed by the target request address within the statistical period;
determine whether the quantity of live rooms accessed by the target request address within the statistical period is less than a preset quantity threshold; and
if the quantity of live rooms accessed by the target request address within the statistical period is less than the preset quantity threshold, determine that the target request address is a blacklist address.

Optionally, the first determining module 706 is further configured to:
determine the updated traffic threshold corresponding to area property of the target area based on a prestored correspondence between area property and a traffic threshold.

Optionally, the pulling information further carries a reporting time. The statistics collection module 704 is further configured to:
determine a reporting time carried in pulling information corresponding to the target request address; and
collect statistics about data traffic carried in corresponding pulling information whose reporting time is within the statistical period, to obtain the total data traffic of the target request address within the statistical period.

Optionally, the authentication server further includes a return module, and the return module is configured to:
generate a blacklist based on a determined blacklist address; and
return the blacklist to the live data server when an obtaining request sent by the live data server is received.

Optionally, the return module is further configured to:
determine whether a target blacklist address that does not exist within a previous statistical period exists within a current statistical period; and
if the target blacklist address that does not exist within the previous statistical period exists within the current statistical period, add the target blacklist address to a blacklist generated within the previous statistical period, to generate a blacklist corresponding to the current statistical period.

Optionally, the return module is further configured to:
when the obtaining request sent by the live data server is received, obtain a target blacklist corresponding to a current statistical period; and
return the target blacklist to the live data server.

In the authentication server provided in this application, statistics about the total data traffic of the target request address within the statistical period can be collected, and a standard for determining a blacklist address for click-farming is dynamically adjusted based on the geographical location of the target request address and the quantity of accessed live rooms, thereby comprehensively determining whether the target request address is a blacklist address for click-farming, avoiding erroneous determining, and improving accuracy of determining a click-farming address.

The foregoing describes a schematic solution of the authentication server in this embodiment. It should be noted that the technical solution of the authentication server apparatus and the technical solution of the data processing method belong to a same concept. For detailed content not described in detail in the technical solution of the authentication server, refer to the descriptions of the technical solution of the data processing method.

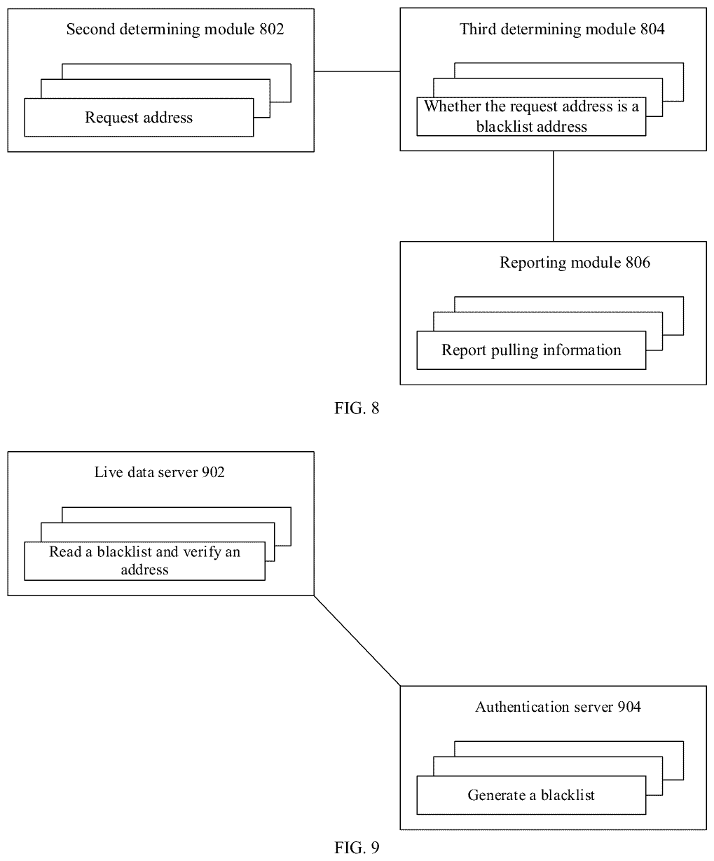

This application further provides a live data server embodiment corresponding to the foregoing method embodiment. FIG. 8 is a schematic diagram of a structure of a live data server according to an embodiment of this application. As shown in FIG. 8, the live data server includes:
a second determining module 802, configured to determine, when a connection establishment request is received, a request address corresponding to the connection establishment request;
a third determining module 804, configured to determine whether the request address is an address in a preset blacklist, establish a connection to a requester when the request address is not an address in the preset blacklist, and return a live video stream to the requester; and
a reporting module 806, configured to collect, at an interval of a reporting period, statistics about data traffic generated through pulling by using the request address within the reporting period, and report pulling information including the request address and the data traffic to an authentication server.

Optionally, the reporting module 806 is further configured to:
determine a live room identifier corresponding to the connection establishment request; and
report the pulling information including the request address, the data traffic, and the live room identifier to the authentication server.

Optionally, the live data server further includes a stop module, and the stop module is configured to:
stop reporting the pulling information when the requester stops obtaining the live video stream.

Optionally, the live data server further includes an update module, and the update module is configured to:
send an obtaining request to the authentication server at an interval of an update period;
receive a blacklist returned by the authentication server, where the blacklist is generated by the authentication server based on total data traffic of the request address within a statistical period; and
update the preset blacklist based on the blacklist returned by the authentication server.

Optionally, the live data server further includes a refusing module, and the refusing module is configured to:
refuse to establish a connection to the requester when the request address is an address in the preset blacklist.

In the live data server provided in this application, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of the livestreaming platform and the live data server. In addition, the live data server can collect, at an interval of the reporting period, statistics about the data traffic generated through pulling by using the request address within the reporting period, and report the data traffic to the authentication server, so that the authentication server analyzes the request address, and confirms whether the request address is a blacklist address for click-farming.

The foregoing describes a schematic solution of the live data server in this embodiment. It should be noted that the technical solution of the live data server and the technical solution of the livestreaming method belong to a same concept. For detailed content not described in detail in the technical solution of the live data server, refer to the descriptions of the technical solution of the livestreaming method.

This application further provides a livestreaming system embodiment corresponding to the foregoing method embodiment. FIG. 9 is a schematic diagram of a structure of a livestreaming system according to an embodiment of this application. As shown in FIG. 9, the system includes a live data server 902 and an authentication server 904.

The live data server 902 is configured to: determine, when a connection establishment request is received, a request address corresponding to the connection establishment request; determine whether the request address is an address in a preset blacklist, establish a connection to a requester when the request address is not an address in the preset blacklist, and return a live video stream to the requester; collect, at an interval of a reporting period, statistics about data traffic generated through pulling by using the request address within the reporting period, and report pulling information including the request address and the data traffic to the authentication server; and send an obtaining request to the authentication server at an interval of an update period.

The authentication server 904 is configured to: obtain the pulling information reported by the live data server, where the pulling information carries the request address and the data traffic generated through pulling within the reporting period; collect statistics about total data traffic of a target request address within a statistical period, and determine, based on the total data traffic, whether the target request address is a blacklist address, where the target request address is a request address carried in any of the pulling information; generate a blacklist based on a determined blacklist address; and return the blacklist to the live data server when the obtaining request sent by the live data server is received.

The live data server 902 is further configured to receive the blacklist returned by the authentication server, and update the preset blacklist based on the blacklist returned by the authentication server.

Optionally, the system further includes a livestreaming platform and a scheduling server.

The livestreaming platform is configured to send a playback request to the scheduling server, where the playback request carries an identifier of a target live room required to be played.

The scheduling server is configured to allocate a playback address of the target live room based on the identifier that is of the target live room and that is carried in the playback request, and return the playback address to the livestreaming platform.

The livestreaming platform is further configured to obtain the playback address returned by the scheduling server, and send the connection establishment request to the live data server based on the playback address.

In the livestreaming system provided in this application, only a normal user whose address is not a blacklist address for click-farming can establish a connection to the live data server, to watch livestreaming, thereby limiting illegal access for click-farming in a pulling origin, disconnecting an illegal connection for click-farming, avoiding an unnecessary bandwidth generated through click-farming, preventing click-farming, saving a bandwidth with high timeliness, and reducing a processing pressure of the livestreaming platform and the live data server. In addition, the live data server can collect, at an interval of the reporting period, statistics about the data traffic generated through pulling by using the request address within the reporting period, and report the data traffic to the authentication server. The authentication server can collect statistics about the total data traffic of the target request address within the statistical period, and dynamically adjust, based on a geographical location of the target request address and a quantity of accessed live rooms, a standard for determining a blacklist address for click-farming, to accurately determine whether the target request address is a blacklist address for click-farming, thereby further ensuring that the live data server can accurately limit illegal access for click-farming, and saving a bandwidth.

The foregoing describes a schematic solution of the livestreaming system in this embodiment. It should be noted that the technical solution of the livestreaming system and the technical solution of the data processing method or the livestreaming method belong to a same concept. For detailed content not described in detail in the technical solution of the livestreaming system, refer to the descriptions of the technical solution of the data processing method or the livestreaming method.

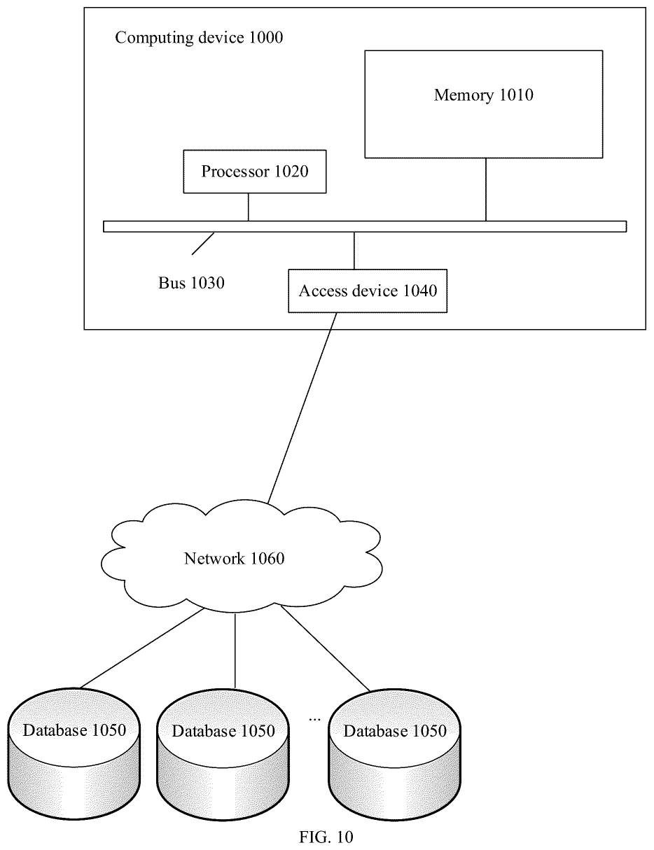

FIG. 10 is a block diagram of a structure of a computing device 1000 according to an embodiment of this application. Components of the computing device 1000 include but are not limited to a memory 1010 and a processor 1020. The processor 1020 and the memory 1010 are connected by using a bus 1030, and a database 1050 is configured to store data.

The computing device 1000 further includes an access device 1040, and the access device 1040 enables the computing device 1000 to communicate via one or more networks 1060. Examples of these networks include a public switched telephone network (PSTN), a local area network (LAN), a wide area network (WAN), a private area network (PAN), or a combination of communication networks such as the Internet. The access device 1040 may include one or more of any type of wired or wireless network interfaces (for example, a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of this application, the foregoing components of the computing device 1000 and other components not shown in FIG. 10 may alternatively be connected to each other, for example, by using the bus. It should be understood that the block diagram of the structure of the computing device shown in FIG. 10 is merely used as an example instead of a limitation on the scope of this application. A person skilled in the art can add or replace other components as required.

The computing device 1000 may be any type of still or mobile computing device, including a mobile computer or a mobile computing device (for example, a pad, a personal digital assistant, a laptop computer, a notebook computer, or a netbook), a mobile phone (for example, a smartphone), a wearable computing device (for example, a smartwatch or smart glasses) or another type of mobile device, or a still computing device, for example, a desktop computer or a PC. The computing device 1000 may alternatively be a mobile or still server.

The processor 1020 is configured to execute the following computer-executable instructions, to implement the operation steps of the foregoing data processing method or livestreaming method.

The foregoing describes a schematic solution of the computing device in this embodiment. It should be noted that the technical solution of the computing device and the technical solution of the data processing method or the livestreaming method belong to a same concept. For detailed content not described in detail in the technical solution of the computing device, refer to the descriptions of the technical solution of the data processing method or the livestreaming method.

An embodiment of this application further provides a computer-readable storage medium. The computer-readable storage medium stores computer-executable instructions, and when the computer-executable instructions are executed by a processor, the operation steps of the foregoing data processing method or livestreaming method are implemented.

The foregoing describes a schematic solution of the computer-readable storage medium in this embodiment. It should be noted that the technical solution of the storage medium and the technical solution of the data processing method or the livestreaming method belong to a same concept. For detailed content not described in detail in the technical solution of the storage medium, refer to the descriptions of the technical solution of the data processing method or the livestreaming method.

The foregoing describes specific embodiments of this application. Other embodiments fall within the scope of the appended claims. In some cases, actions or steps described in the claims may be performed in a sequence different from that in embodiments and a desired result may still be achieved. In addition, processes depicted in the accompanying drawings do not necessarily require the shown particular sequences or consecutive sequences to achieve desired results. In some implementations, multi-task processing and parallel processing can or may be advantageous.

The computer instructions include computer program code. The computer program code may be in a source code form, an object code form, an executable file form, an intermediate form, or the like. The computer-readable medium may include any entity or apparatus, a recording medium, a USB flash drive, a removable hard disk, a magnetic disk, an optical disc, a computer memory, a read-only memory (ROM), a random access memory (RAM), an electrical carrier signal, a telecommunications signal, a software distribution medium, and the like that can carry the computer program code. It should be noted that content included in the computer-readable medium may be appropriately added or deleted according to the demands of legislation and patent practice in a jurisdiction, for example, in some jurisdictions, according to legislation and patent practice, the computer-readable medium includes neither an electrical carrier signal nor a telecommunications signal.

It should be noted that, for ease of description, the foregoing method embodiments are described as a combination of a series of actions. However, a person skilled in the art should understand that this application is not limited to the described action sequence, because according to this application, some steps may be performed in another sequence or simultaneously. In addition, a person skilled in the art should also understand that the described embodiments in this specification are all preferred embodiments, and involved actions and modules are not necessarily mandatory to this application.

In the foregoing embodiments, the descriptions of the embodiments have respective focuses. For a part that is not described in detail in a specific embodiment, refer to related descriptions in another embodiment.

The foregoing disclosed preferred embodiments of this application are merely intended to help describe this application. In the optional embodiments, not all details are described in detail, and the present invention is not limited to only the specific implementations. Obviously, many modifications and changes may be made based on the content of this application. These embodiments are selected and specifically described in this application to better explain the principle and the actual applications of this application, so that a person skilled in the art can better understand and use this application. This application is limited to only the claims and the scope and equivalents thereof.

1. A method of processing data, applied to an authentication server, comprising:
obtaining pulling information reported by a live data server, wherein the pulling information carries at least one request address and data traffic generated through pulling within a reporting period, wherein the pulling information is periodically reported by the live data server at an interval of the reporting period, and wherein the live data server stops reporting the pulling information in response to determining that the at least one request address stops obtaining a live vide stream from the live data server;
computing total data traffic associated with a target request address within a statistical period; and
determining, based on the total data traffic, whether the target request address is a blacklist address, wherein the target request address is any request address carried in the pulling information.

2. The method according to claim 1, wherein the determining, based on the total data traffic, whether the target request address is a blacklist address further comprises:
determining whether the total data traffic is greater than an initial traffic threshold; and
determining, based on a geographical location of the target request address, whether the target request address is a blacklist address when the total data traffic is greater than the initial traffic threshold.

3. The method according to claim 2, wherein the determining, based on a geographical location of the target request address, whether the target request address is a blacklist address further comprises:
determining a target area to which the geographical location of the target request address belongs;
determining a request address reuse value corresponding to the target area, and determining whether the request address reuse value of the target area is greater than a preset threshold;
determining a corresponding updated traffic threshold based on the target area when the request address reuse value of the target area is greater than the preset threshold;
determining whether the total data traffic is greater than the updated traffic threshold; and
determining, based on a quantity of live rooms accessed by the target request address within the statistical period, whether the target request address is a blacklist address when the total data traffic is greater than the updated traffic threshold.

4. The method according to claim 3, wherein the determining a request address reuse value corresponding to the target area further comprises at least one of:
determining the request address reuse value corresponding to the target area based on an area attribute of the target area;
determining the request address reuse value corresponding to the target area based on the area attribute of the target area and a statistical time; or
determining the request address reuse value corresponding to the target area based on a population density of the target area.

5. The method according to claim 3, wherein the pulling information further carries live room identifiers; and the determining, based on a quantity of live rooms accessed by the target request address within the statistical period, whether the target request address is a blacklist address further comprises:
calculating, based on one or more live room identifiers carried in the pulling information corresponding to the target request address, the quantity of live rooms accessed by the target request address within the statistical period;
determining whether the quantity of live rooms accessed by the target request address within the statistical period is less than a preset quantity threshold; and
determining that the target request address is a blacklist address when the quantity of live rooms accessed by the target request address within the statistical period is less than the preset quantity threshold.

6. The method according to claim 3, wherein the determining a corresponding updated traffic threshold based on the target area further comprises:
determining the updated traffic threshold corresponding to an area attribute of the target area based on prestored correspondences between area attributes and traffic thresholds.

7. The method according to claim 1, wherein the pulling information further carries reporting times; and the computing total data traffic associated with a target request address within a statistical period further comprises:
determining one or more reporting times carried in the pulling information corresponding to the target request address; and
computing data traffic carried in corresponding pulling information with the one or more reporting times that are within the statistical period to obtain the total data traffic of the target request address within the statistical period.

8. The method according to claim 1, wherein after the determining, based on the total data traffic, whether the target request address is a blacklist address, the method further comprises:
generating a blacklist based on a determined blacklist address; and
returning the blacklist to the live data server in response to receiving an obtaining request from the live data server.

9. The method according to claim 8, wherein the generating a blacklist based on a determined blacklist address further comprises:
determining whether a target blacklist address exists within a current statistical period, wherein the target blacklist address does not exist within a previous statistical period; and
generating a blacklist corresponding to the current statistical period by adding the target blacklist address to a blacklist generated within the previous statistical period.

10. The method according to claim 8, wherein the returning the blacklist to the live data server in response to receiving an obtaining request from the live data server further comprises:
obtaining a target blacklist corresponding to a current statistical period in response to receiving the obtaining request from the live data server; and
returning the target blacklist to the live data server.

11.-19. (canceled)

20. A computing system, comprising:
a memory and a processor, wherein the memory is configured to store computer-executable instructions, and wherein the computer-executable instructions upon execution by the processor cause the processor to implement operations comprising:
obtaining pulling information reported by a live data server, wherein the pulling information carries at least one request address and data traffic generated through pulling within a reporting period, wherein the pulling information is periodically reported by the live data server at an interval of the reporting period, and wherein the live data server stops reporting the pulling information in response to determining that the at least one request address stops obtaining a live vide stream from the live data server;
computing total data traffic associated with a target request address within a statistical period; and
determining, based on the total data traffic, whether the target request address is a blacklist address, wherein the target request address is any request address carried in the pulling information.

21. A non-transitory computer-readable storage medium, storing computer-executable instructions, wherein the computer-executable instructions upon execution by a processor cause the processor to implement operations comprising:
obtaining pulling information reported by a live data server, wherein the pulling information carries at least one request address and data traffic generated through pulling within a reporting period, wherein the pulling information is periodically reported by the live data server at an interval of the reporting period, and wherein the live data server stops reporting the pulling information in response to determining that the at least one request address stops obtaining a live vide stream from the live data server;
computing total data traffic associated with a target request address within a statistical period; and
determining, based on the total data traffic, whether the target request address is a blacklist address, wherein the target request address is any request address carried in the pulling information.

22. (canceled)

23. The computing system according to claim 20, wherein the determining, based on the total data traffic, whether the target request address is a blacklist address further comprises:
determining whether the total data traffic is greater than an initial traffic threshold; and
determining, based on a geographical location of the target request address, whether the target request address is a blacklist address when the total data traffic is greater than the initial traffic threshold.

24. The computing system according to claim 23, wherein the determining, based on a geographical location of the target request address, whether the target request address is a blacklist address further comprises:
determining a target area to which the geographical location of the target request address belongs;
determining a request address reuse value corresponding to the target area, and determining whether the request address reuse value of the target area is greater than a preset threshold;
determining a corresponding updated traffic threshold based on the target area when the request address reuse value of the target area is greater than the preset threshold;
determining whether the total data traffic is greater than the updated traffic threshold; and
determining, based on a quantity of live rooms accessed by the target request address within the statistical period, whether the target request address is a blacklist address when the total data traffic is greater than the updated traffic threshold.

25. The computing system according to claim 24, wherein the determining a request address reuse value corresponding to the target area further comprises at least one of:
determining the request address reuse value corresponding to the target area based on an area attribute of the target area;
determining the request address reuse value corresponding to the target area based on the area attribute of the target area and a statistical time; or
determining the request address reuse value corresponding to the target area based on a population density of the target area.

26. The computing system according to claim 24, wherein the pulling information further carries live room identifiers; and the determining, based on a quantity of live rooms accessed by the target request address within the statistical period, whether the target request address is a blacklist address further comprises:
calculating, based on one or more live room identifiers carried in the pulling information corresponding to the target request address, the quantity of live rooms accessed by the target request address within the statistical period;
determining whether the quantity of live rooms accessed by the target request address within the statistical period is less than a preset quantity threshold; and
determining that the target request address is a blacklist address when the quantity of live rooms accessed by the target request address within the statistical period is less than the preset quantity threshold.

27. The computing system according to claim 24, wherein the determining a corresponding updated traffic threshold based on the target area further comprises:
determining the updated traffic threshold corresponding to an area attribute of the target area based on prestored correspondences between area attributes and traffic thresholds.

28. The computing system according to claim 20, wherein the pulling information further carries reporting times; and the computing total data traffic associated with a target request address within a statistical period further comprises:
determining one or more reporting times carried in the pulling information corresponding to the target request address; and
computing data traffic carried in corresponding pulling information with the one or more reporting times that are within the statistical period to obtain the total data traffic of the target request address within the statistical period.

29. The computing system according to claim 20, wherein after the determining, based on the total data traffic, whether the target request address is a blacklist address, the method further comprises:
generating a blacklist based on a determined blacklist address; and
returning the blacklist to the live data server in response to receiving an obtaining request from the live data server.

30. The computing system according to claim 28, wherein the returning the blacklist to the live data server in response to receiving an obtaining request from the live data server further comprises:
obtaining a target blacklist corresponding to a current statistical period in response to receiving the obtaining request from the live data server; and
returning the target blacklist to the live data server.
